(19) United States
(12) Patent Application Publication
(10) Pub. No.: US 2016/0188545 A1
(43) Pub. Date: Jun. 30, 2016

(54) REUSABLE CONTENT UNITS

(71) Applicants: Domenic Santangelo, Gilroy, CA (US); Erik Levinson, Pleasanton, CA (US)

(72) Inventors: Domenic Santangelo, Gilroy, CA (US); Erik Levinson, Pleasanton, CA (US)

(21) Appl. No.: 14/585,502

(22) Filed: Dec. 30, 2014

(51) Int. Cl. G06F 17/22; G06F 17/21; G06F 3/0484; G06F 17/24

(52) U.S. Cl. CPC G06F 17/2247; G06F 17/2264; G06F 17/24; G06F 17/211; G06F 3/04847; G06F 3/04842

(57) ABSTRACT

Methods, systems, and apparatus for creating content, such as web pages, are described. In one example embodiment, a panel is instantiated and one or more content unit types are selected and added to the panel. Each content unit is customized based on the corresponding content unit type and may be edited via a user interface. Defined content units may be processed to generate the content in, for example, the hypertext markup language.

### TECHNICAL FIELD

The present application relates generally to creating media content, and more specifically, in one example, to using reusable content units to create internet content.

### BACKGROUND

The creation of media content, such as the generation of web pages, often requires complex programming skills. The web pages may be based on a markup language such as the HyperText Markup Language (HTML). Users may create a variety of webpages using HTML that may include text, graphics, images, videos, audio clips, and the like. The creation of the webpages often calls for extensive expertise and understanding of, for example, the semantics and syntax of HTML.

### BRIEF DESCRIPTION OF THE DRAWINGS

Some embodiments are illustrated by way of example and not limitation in the figures of the accompanying drawings, in which:

FIG. 1A is a network diagram depicting a client-server system, in accordance with an example embodiment;

FIG. 1B is a block diagram illustrating marketplace and payment applications, in accordance with an example embodiment;

FIG. 2 is a block diagram of an example apparatus for creating content, in accordance with an example embodiment;

FIG. 3 illustrates an example web page rendered from a plurality of stacked content units, in accordance with an example embodiment;

FIG. 4 is a list of example content unit types, in accordance with an example embodiment;

FIG. 5 illustrates components of an example web page generated from a call to action content unit, in accordance with an example embodiment;

FIG. 6 illustrates an example user interface for defining the components of the call to action content unit, in accordance with an example embodiment;

FIGS. 7A and 7B illustrate an example user interface for defining the components of a header large media slideshow content unit, in accordance with an example embodiment;

FIG. 8A illustrates an example panel for creating a web page using content units, in accordance with an example embodiment

FIG. 8B illustrates an example user interface for defining a panel comprising a stack of content units, in accordance with an example embodiment;

FIG. 8C illustrates an example user interface for accessing content units of a defined panel, in accordance with an example embodiment;

FIG. 9 illustrates an example workflow for creating content, in accordance with an example embodiment;

FIG. 10 is a flowchart for an example method for generating content, in accordance with an example embodiment;

FIGS. 11A-11C are examples of code for defining the style of a content unit and specifying the parameters for the content, in accordance with an example embodiment;

FIG. 12 is a block diagram illustrating an example mobile device, according to an example embodiment; and

FIG. 13 is a block diagram of a machine within which instructions may be executed for causing the machine to perform any one or more of the methodologies discussed herein.

### DETAILED DESCRIPTION

In the following detailed description of example embodiments, reference is made to specific examples by way of drawings and illustrations. These examples are described in sufficient detail to enable those skilled in the art to practice these example embodiments, and serve to illustrate how the invention may be applied to various purposes or embodiments. Other embodiments of the invention exist and are within the scope of the invention, and logical, mechanical, electrical, and other changes may be made without departing from the scope or extent of the present invention. Features or limitations of various embodiments of the invention described herein, however essential to the example embodiments in which they are incorporated, do not limit the invention as a whole, and any reference to the invention, its elements, operation, and application do not limit the invention as a whole but serve only to define these example embodiments. The following detailed description does not, therefore, limit the scope of the invention, which is defined only by the appended claims.

Generally, methods, systems, and apparatus for creating content, such as web pages and multimedia content, are described. In one example embodiment, content units are customized to generate a web page. Each content unit is a building block for creating content, such as a building block of a web page, and has a defined layout, number, and type of text fields, colors, and the like. Each type of content unit has one or more defined purposes such as slideshow/carousel, call to action, large graphic, and the like, as described more fully below. The content unit may be customized using, for example, basic user input. A plurality of content units may be stacked or otherwise joined together to create a web page or a group of web pages.

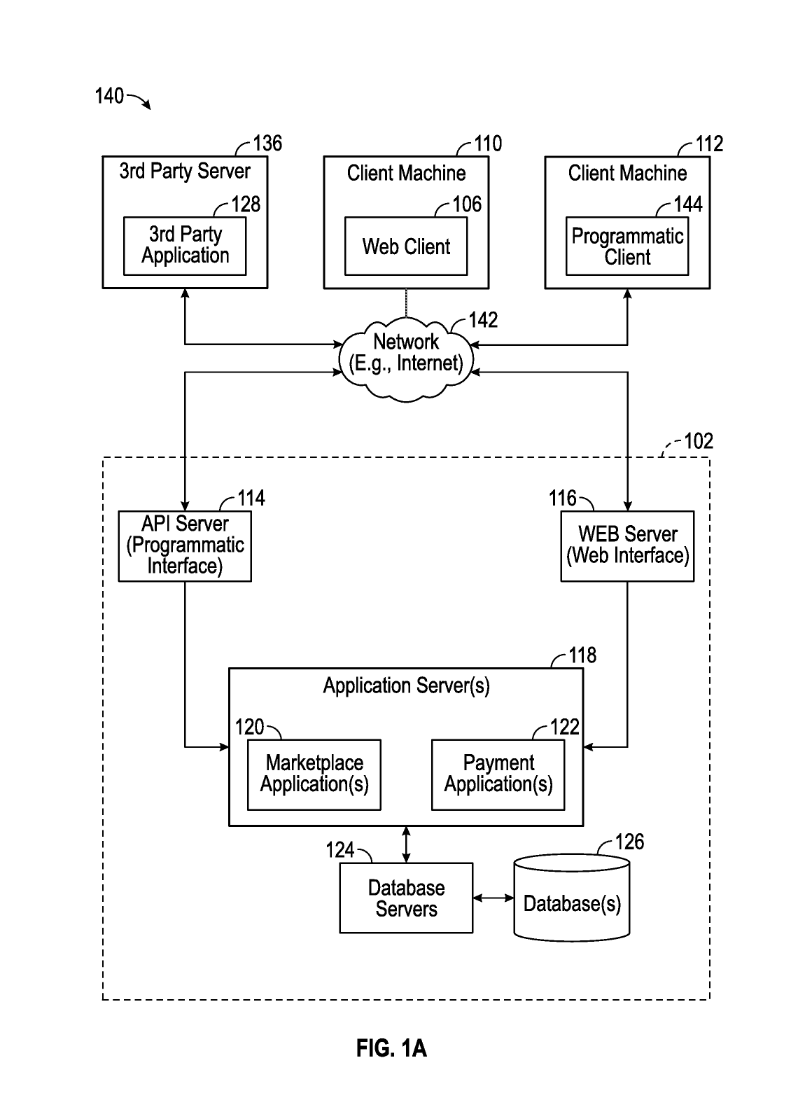

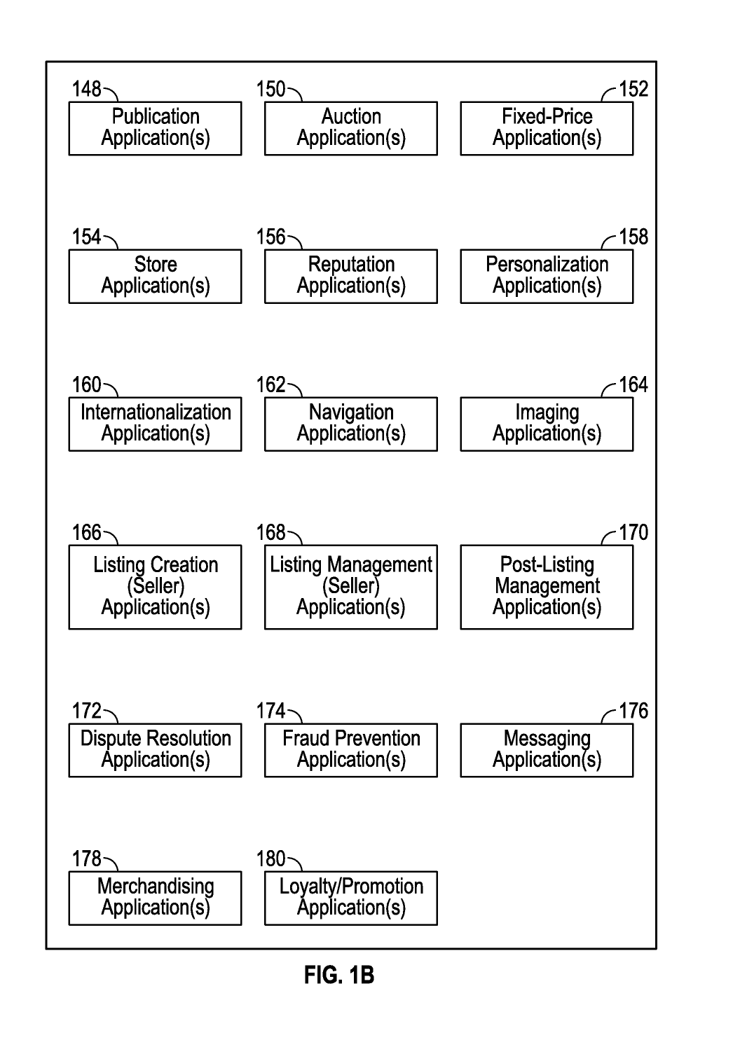

FIG. 1A is a network diagram depicting a client-server system 140, in accordance with an example embodiment. A networked system 102, in the example forms of a network-based marketplace or publication system, provides server-side functionality, via a network 142 (e.g., the Internet or a Wide Area Network (WAN)), to one or more clients. FIG. 1A illustrates, for example, a web client 106 (e.g., a browser, such as the Internet Explorer® browser developed by Microsoft® Corporation of Redmond, Wash.) and a programmatic client 144 executing on respective devices 110 and 112.

An Application Program Interface (API) server 114 and a web server 116 are coupled to, and provide programmatic and web interfaces respectively to, one or more application servers 118. The application server(s) 118 hosts one or more marketplace applications 120 and payment applications 122. The application server(s) 118 is, in turn, shown to be coupled to one or more database servers 124 that facilitate access to one or more databases 126.

The marketplace application(s) 120 may provide a number of marketplace functions and services to users who access the networked system 102. The marketplace application(s) 120 are examples of applications upon which a user may provide suggestions and/or defect reports. The payment application(s) 122 may likewise provide a number of payment services and functions to users. The payment application(s) 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace application(s) 120. While the marketplace and payment applications 120 and 122 are shown in FIG. 1A to both form part of the networked system 102, it will be appreciated that, in alternative embodiments, the payment application(s) 122 may form part of a payment service that is separate and distinct from the networked system 102.

Further, while the system 140 shown in FIG. 1A employs a client-server architecture, the embodiments are, of course, not limited to such an architecture, and could equally well find application in a distributed, or peer-to-peer, architecture system, for example. The various marketplace and payment applications 120 and 122 could also be implemented as standalone software programs, which do not necessarily have networking capabilities.

The web client 106 accesses the various marketplace and payment applications 120 and 122 via the web interface supported by the web server 116. Similarly, the programmatic client 144 accesses the various services and functions provided by the marketplace and payment applications 120 and 122 via the programmatic interface provided by the API server 114. The programmatic client 144 may, for example, be a seller application (e.g., the Turbo Lister application developed by eBay Inc., of San Jose, Calif.) to enable sellers to author and manage listings on the networked system 102 in an offline manner, and to perform batch-mode communications between the programmatic client 144 and the networked system 102.

FIG. 1A also illustrates a third party application 128, executing on a third party server machine 136, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace, or payment functions that are supported by the relevant applications of the networked system 102.

FIG. 1B is a block diagram illustrating marketplace and payment applications 120 and 122, in accordance with an example embodiment. In one example embodiment, feedback items regarding the marketplace and payment applications 120 and 122 may be obtained from, for example, users of the marketplace and payment applications 120 and 122, and the feedback items may be mined using the techniques described herein. In one example embodiment, the marketplace and payment applications 120 and 122 are provided as part of application server(s) 118 in the networked system 102. The applications 120 and 122 may be hosted on dedicated or shared server machines (not shown) that are communicatively coupled to enable communications between server machines. The applications 120 and 122 themselves are communicatively coupled (e.g., via appropriate interfaces) to each other and to various data sources, so as to allow information to be passed between the applications 120 and 122 or so as to allow the applications 120 and 122 to share and access common data. The applications 120 and 122 may furthermore access one or more databases 126 via the database servers 124.

The networked system 102 may provide a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace and payment applications 120 and 122 are shown to include at least one publication application 148. The publication application 148 may enable the creation of content using content units, as described more fully below.

In one example embodiment, the marketplace and payment applications 120 and 122 are shown to include one or more auction applications 150, which support auction-format listing and price setting mechanisms (e.g., English, Dutch, Vickrey, Chinese, Double, Reverse auctions, etc.). The various auction applications 150 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 152 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 154 allow a seller to group listings within a “virtual” store, which may be branded and otherwise personalized by and for the seller. Such a virtual store may also offer promotions, incentives, and features that are specific and personalized to a relevant seller.

Reputation applications 156 allow users who transact, utilizing the networked system 102, to establish, build, and maintain reputations, which may be made available and published to potential trading partners. Consider that where, for example, the networked system 102 supports person-to-person trading, users may otherwise have no history or other reference information whereby the trustworthiness and credibility of potential trading partners may be assessed. The reputation applications 156 allow a user (for example, through feedback provided by other transaction partners) to establish a reputation within the networked system 102 over time. Other potential trading partners may then reference such a reputation for the purposes of assessing credibility and trustworthiness.

Personalization applications 158 allow users of the networked system 102 to personalize various aspects of their interactions with the networked system 102. For example a user may, utilizing an appropriate personalization application 158, create a personalized reference page at which information regarding transactions to which the user is (or has been) a party may be viewed. Further, a personalization application 158 may enable a user to personalize listings and other aspects of their interactions with the networked system 102 and other parties.

The networked system 102 may support a number of marketplaces that are customized, for example, for specific geographic regions. A version of the networked system 102 may be customized for the United Kingdom, whereas another version of the networked system 102 may be customized for the United States. Each of these versions may operate as an independent marketplace or may be customized (or internationalized) presentations of a common underlying marketplace. The networked system 102 may accordingly include a number of internationalization applications 160 that customize information (and/or the presentation of information by the networked system 102) according to predetermined criteria (e.g., geographic, demographic or marketplace criteria). For example, the internationalization applications 160 may be used to support the customization of information for a number of regional websites that are operated by the networked system 102 and that are accessible via respective web servers 116.

Navigation of the networked system 102 may be facilitated by one or more navigation applications 162. For example, a search application (as an example of a navigation application 162) may enable key word searches of listings published via the networked system 102. A browse application may allow users to browse various category, catalogue, or inventory data structures according to which listings may be classified within the networked system 102. Various other navigation applications 162 may be provided to supplement the search and browsing applications.

In order to make listings available via the networked system 102 as visually informing and attractive as possible, the applications 120 and 122 may include one or more imaging applications 164, which users may utilize to upload images for inclusion within listings. An imaging application 164 also operates to incorporate images within viewed listings. The imaging applications 164 may also support one or more promotional features, such as image galleries that are presented to potential buyers. For example, sellers may pay an additional fee to have an image included within a gallery of images for promoted items.

Listing creation applications 166 allow sellers to conveniently author listings pertaining to goods or services that they wish to transact via the networked system 102, and listing management applications 168 allow sellers to manage such listings. Specifically, where a particular seller has authored and/or published a large number of listings, the management of such listings may present a challenge. The listing management applications 168 provide a number of features (e.g., auto-relisting, inventory level monitors, etc.) to assist the seller in managing such listings. One or more post-listing management applications 170 also assist sellers with a number of activities that typically occur post-listing. For example, upon completion of an auction facilitated by one or more auction applications 150, a seller may wish to leave feedback regarding a particular buyer. To this end, a post-listing management application 170 may provide an interface to one or more reputation applications 156, so as to allow the seller conveniently to provide feedback regarding multiple buyers to the reputation applications 156.

Dispute resolution applications 172 provide mechanisms whereby disputes arising between transacting parties may be resolved. For example, the dispute resolution applications 172 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 174 implement fraud detection and prevention mechanisms to reduce the occurrence of fraud within the networked system 102.

Messaging applications 176 are responsible for the generation and delivery of messages to users of the networked system 102 (such as, for example, messages advising users regarding the status of listings at the networked system 102 (e.g., providing “outbid” notices to bidders during an auction process or to provide promotional and merchandising information to users)). Respective messaging applications 176 may utilize any one of a number of message delivery networks and platforms to deliver messages to users. For example, messaging applications 176 may deliver electronic mail (e-mail), instant message (IM), Short Message Service (SMS), text, facsimile, or voice (e.g., Voice over IP (VoIP)) messages via the wired (e.g., the Internet), plain old telephone service (POTS), or wireless (e.g., mobile, cellular, WiFi, WiMAX) networks 142.

Merchandising applications 178 support various merchandising functions that are made available to sellers to enable sellers to increase sales via the networked system 102. The merchandising applications 178 also operate the various merchandising features that may be invoked by sellers, and may monitor and track the success of merchandising strategies employed by sellers. The networked system 102 itself, or one or more parties that transact via the networked system 102, may operate loyalty programs that are supported by one or more loyalty/promotions applications 180. For example, a buyer may earn loyalty or promotion points for each transaction established and/or concluded with a particular seller, and be offered a reward for which accumulated loyalty points can be redeemed.

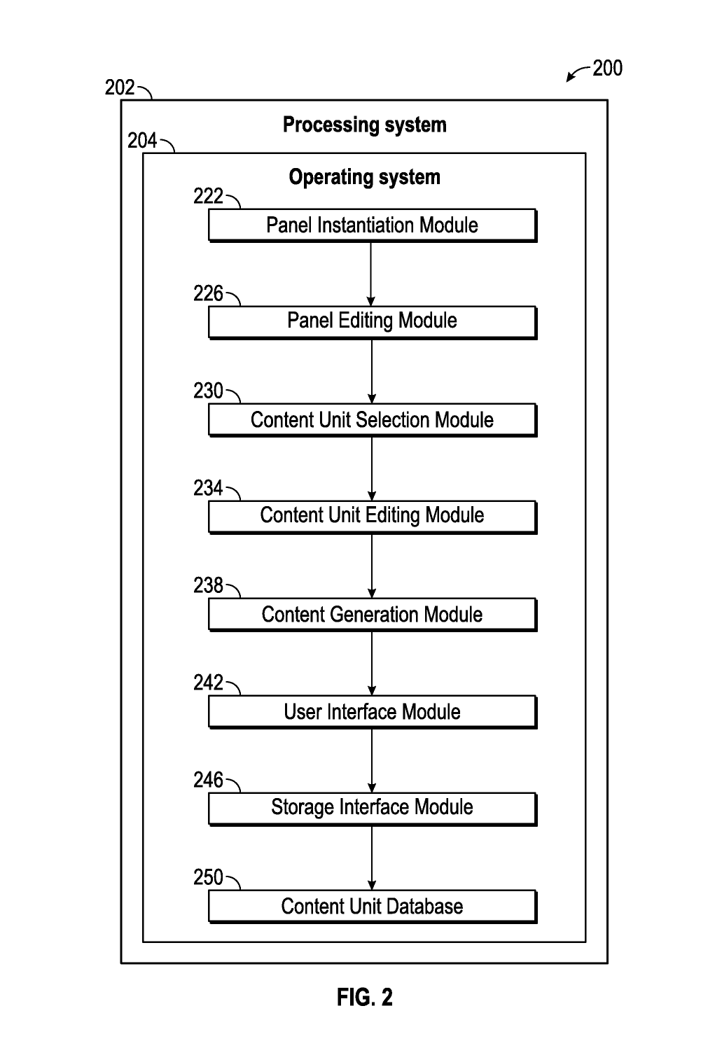

FIG. 2 is a block diagram of an example apparatus 200 for creating content, in accordance with an example embodiment. The apparatus 200 is shown to include a processing system 202 that may be implemented on a client or other processing device that includes an operating system 204 for executing software instructions.

In accordance with an example embodiment, the apparatus 200 may include a panel instantiation module 222, a panel editing module 226, a content unit selection module 230, a content unit editing module 234, a content generation module 238, and a user interface module 242. In accordance with an example embodiment, the apparatus 200 may further include a storage interface module 246 and a content unit database 250.

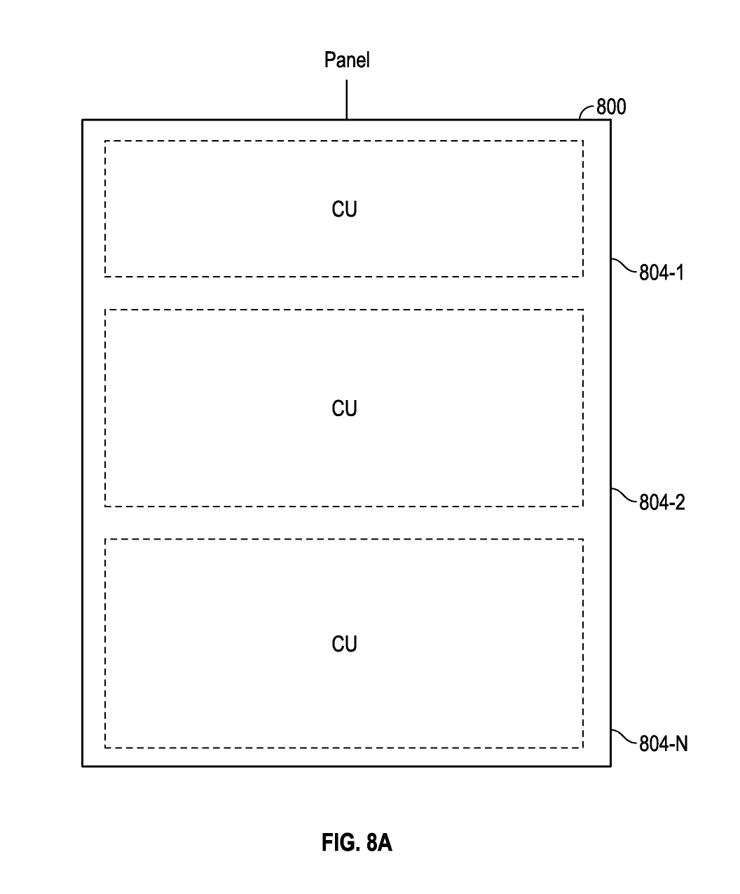

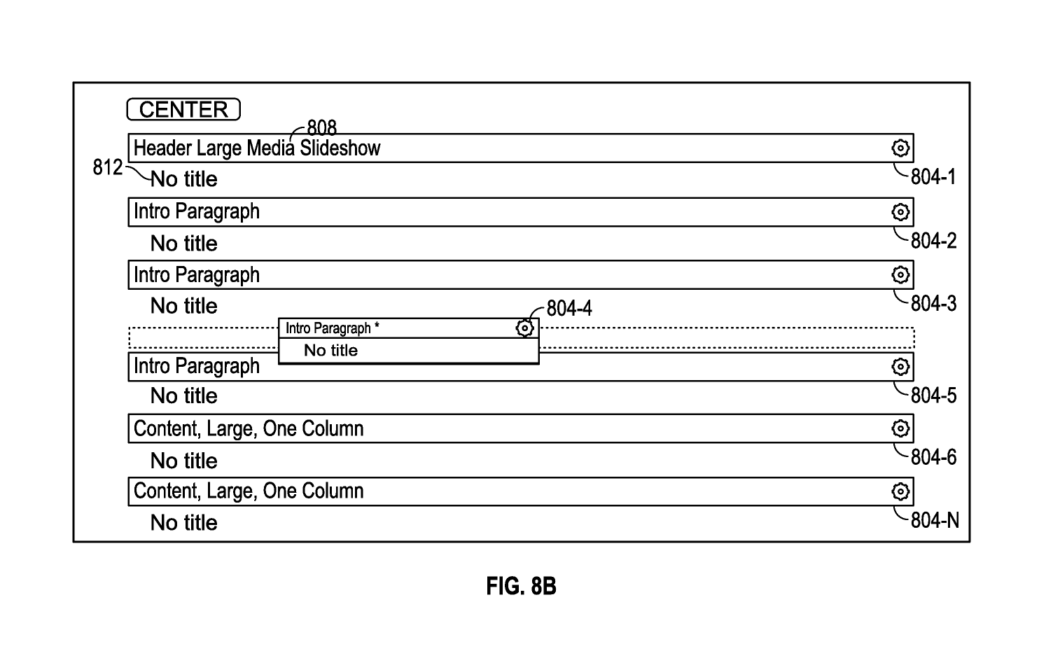

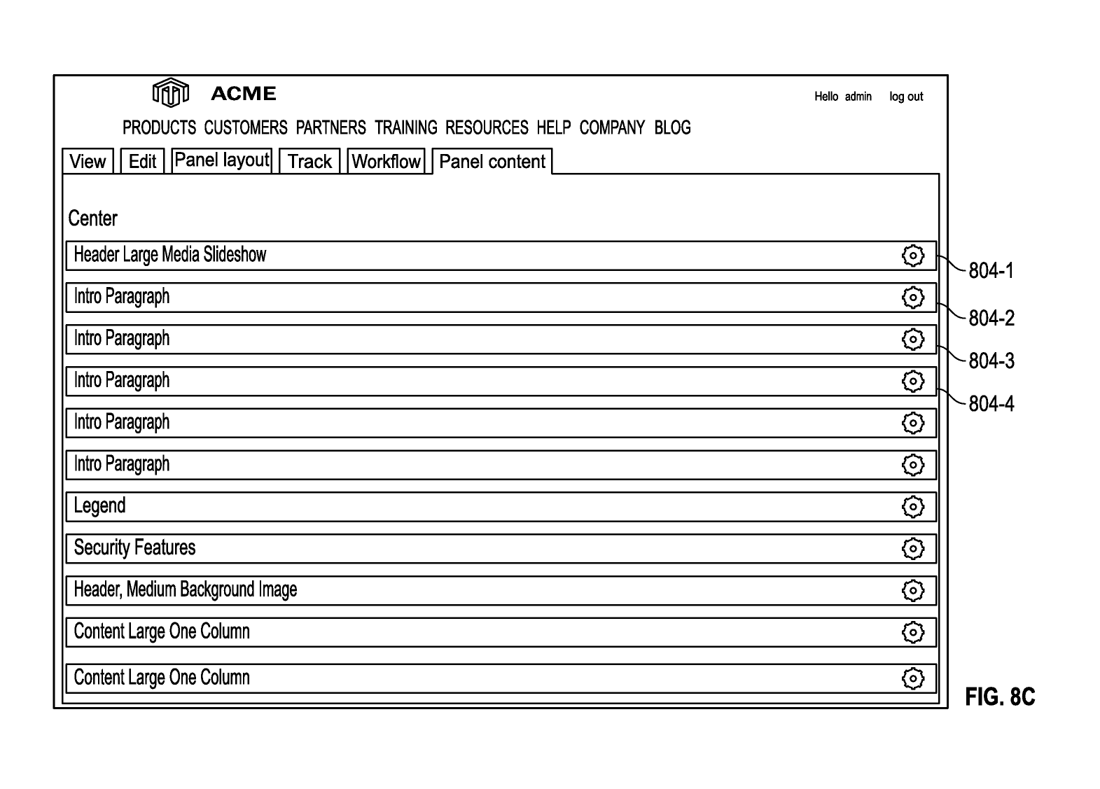

The panel instantiation module 222 enables a user to instantiate a panel for generating content using content units. In one example embodiment, the panel is a single page container for one or more stacked content units, as described more fully below in conjunction with FIGS. 8A-8C. The panel editing module 226 enables a user to add, move, or delete content unit blocks from the content unit stack of the panel using, for example, a drag-and-drop technique.

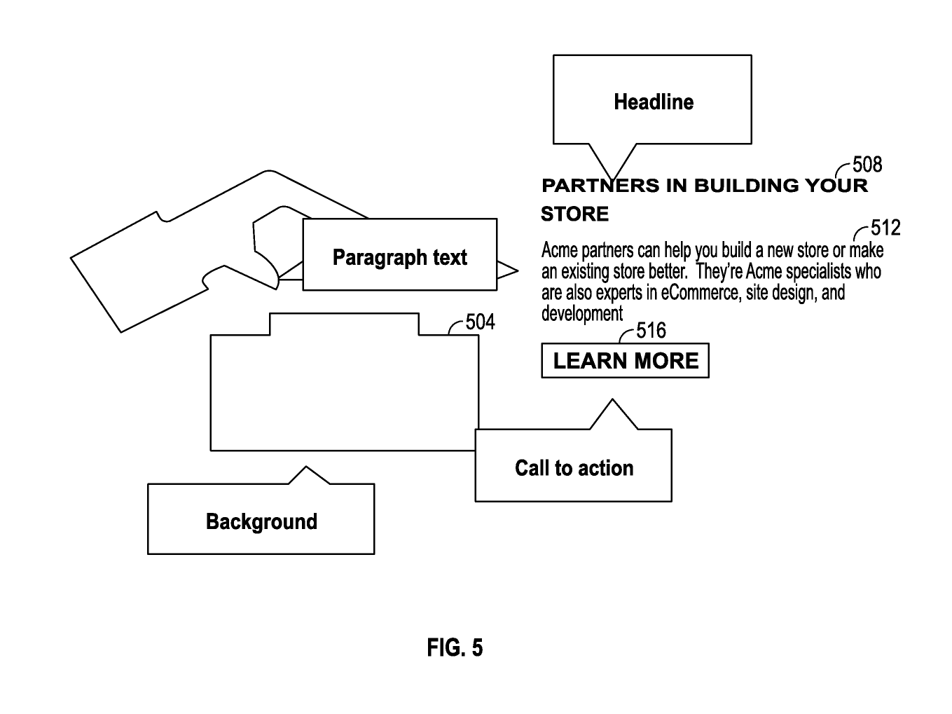

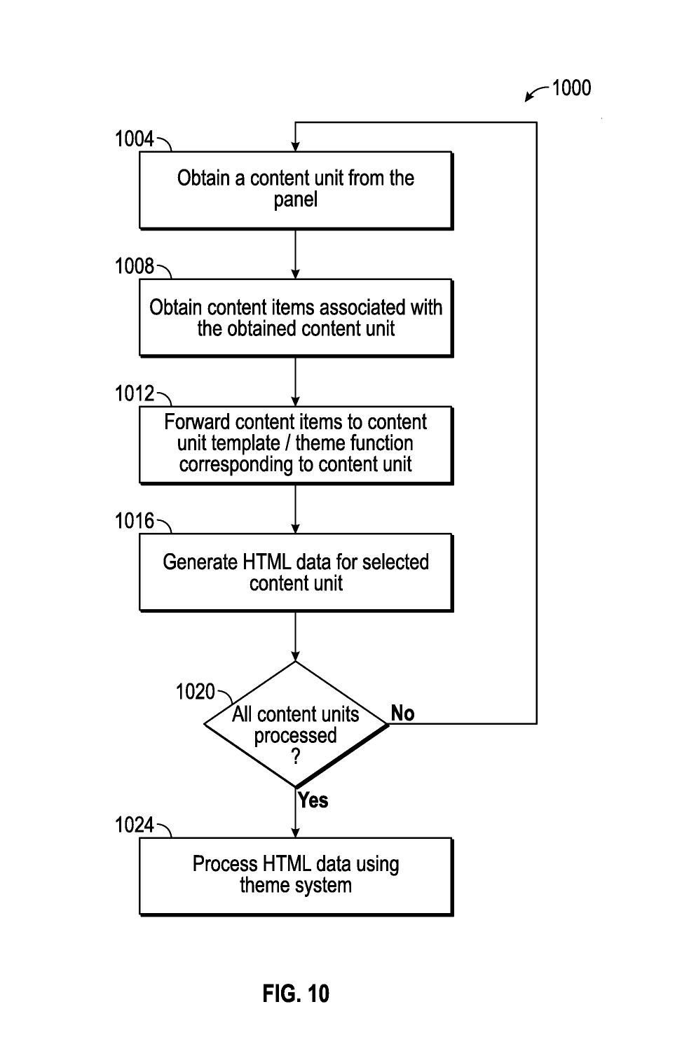

The content unit selection module 230 enables a user to select a content unit for insertion in a panel and/or for editing the content unit, as described more fully below in conjunction with FIGS. 5, 6, and 7A-7B. The content unit editing module 234 enables a user to customize a new content unit and/or edit an existing content unit. The content generation module 238 generates content from defined content units, as described more fully below in conjunction with FIG. 10. For example, the content generation module 238 may generate HTML data from one or more content units.

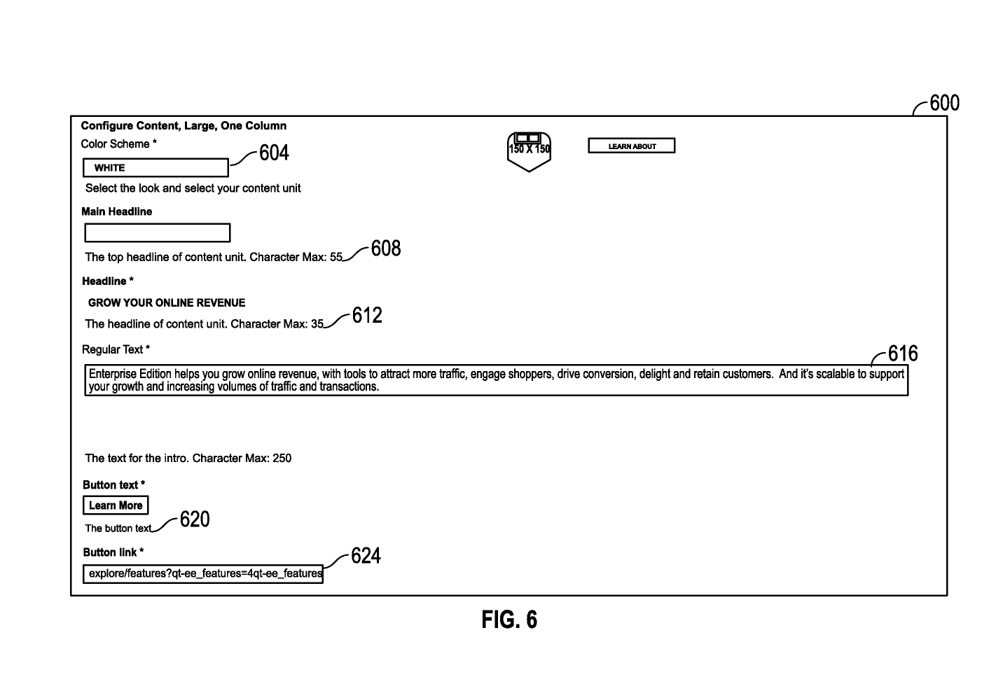

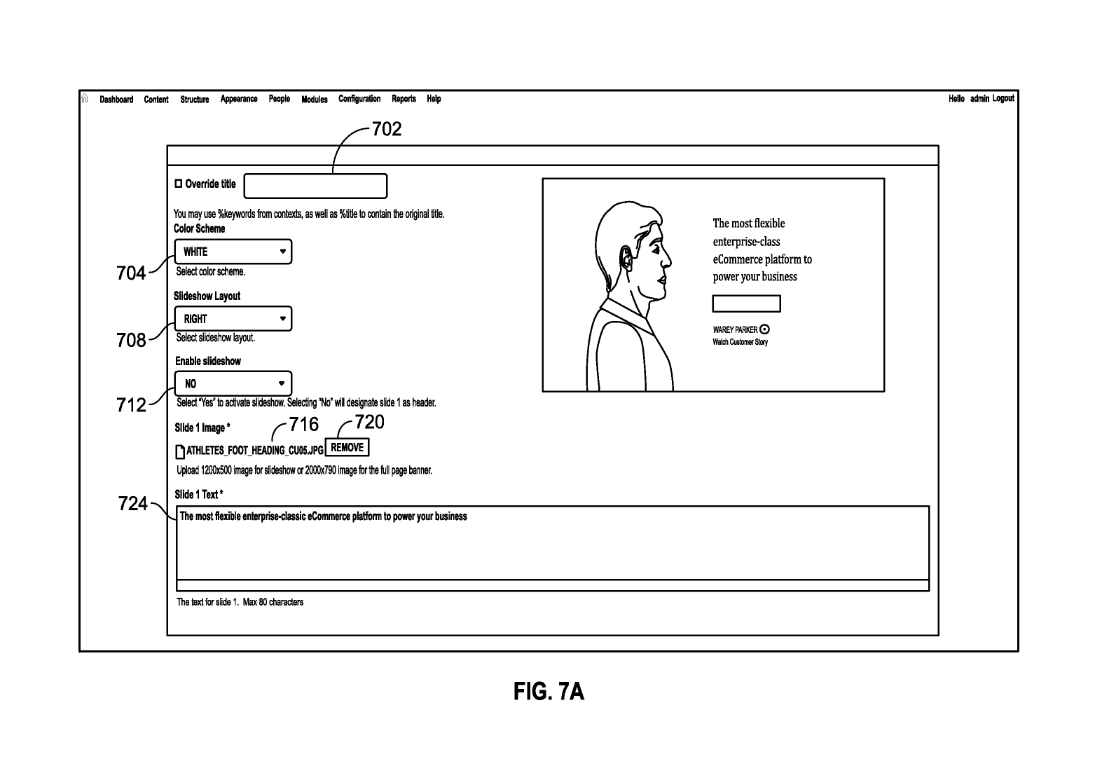

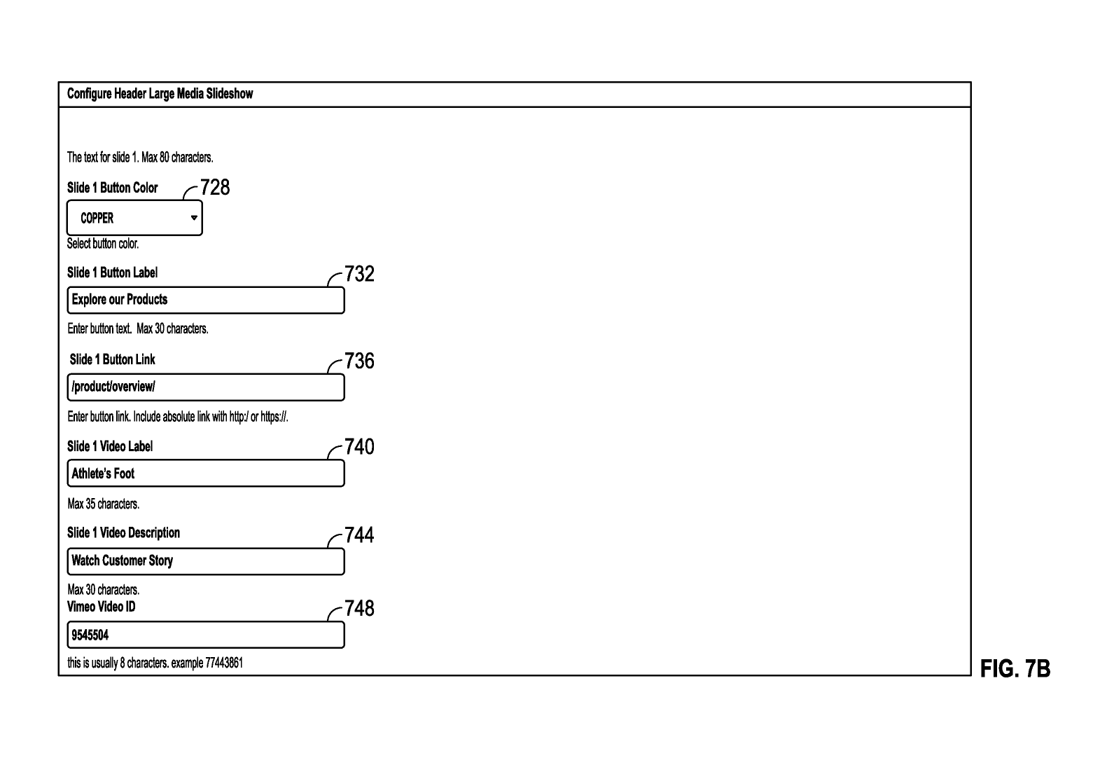

The user interface module 242 enables a user to define panels and content units, as described more fully below in conjunction with FIGS. 6, 7A, and 7B. In one example embodiment, the user interface module 242 enables a user to preview content prior to rendering.

The storage interface module 246 provides, for example, an interface for accessing images, graphics, videos, audio clips, and the like stored in various databases, archives, and other types of storage facilities that may be imported into the created content. The content unit database 250 provides storage for reusable content units, customized content units, panels, and the like.

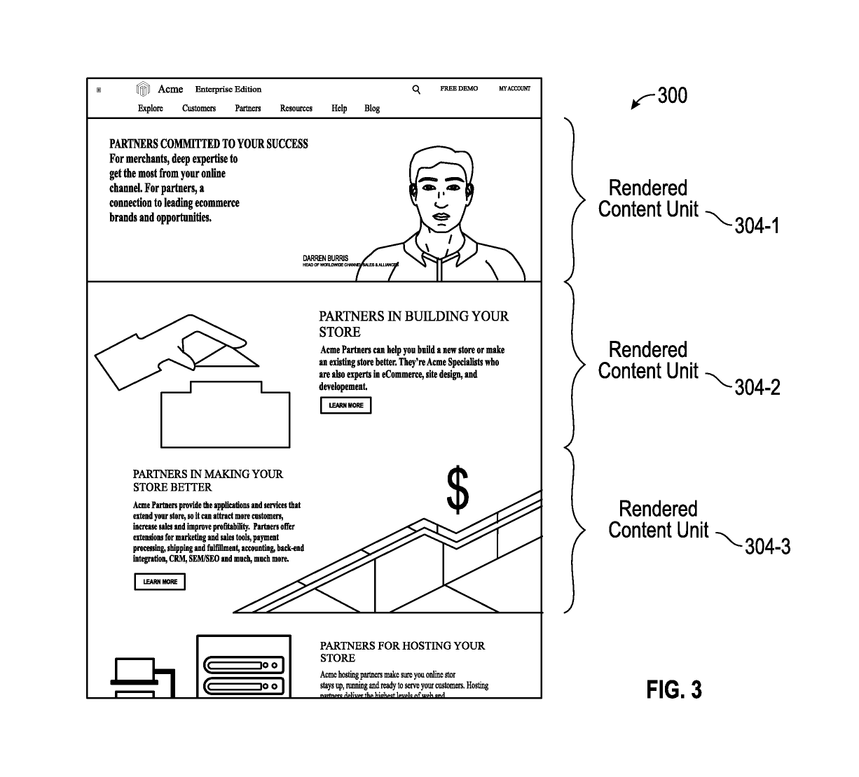

FIG. 3 illustrates an example web page 300 rendered from a plurality of stacked content units, in accordance with an example embodiment. Rendered content units 304-1 through 304-3 (hereinafter rendered content units 304) are each generated from a content unit that has been customized by, for example, a user. Each type of content unit may be reused to generate a plurality of customized rendered content units 304.

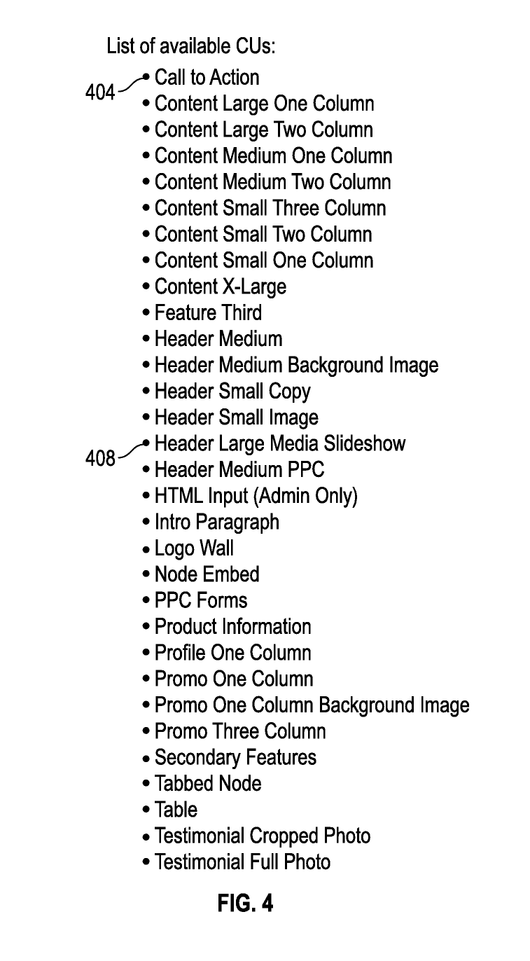

FIG. 4 is a list of example content unit types, in accordance with an example embodiment. Each type of content unit has one or more defined purposes such as slideshow/carousel, call to action, large graphic, and the like. For example, a call to action content unit 404 is a content unit type for generating a web page that enables a user of the rendered content unit to trigger an action, such as retrieving additional information, as described more fully below in conjunction with FIGS. 5 and 6. In one example embodiment, the action is the retrieval of another web page via a link. In another example, a header large media slideshow content unit 408 is a content unit type for generating a web page that enables a user of the rendered content unit 404, 408 to view an image and access a video, as described more fully below in conjunction with FIGS. 7A and 7B.

FIG. 5 illustrates components of an example web page generated from the call to action content unit 404, in accordance with an example embodiment. The components include a background 504 (such as an image, graphics, text, and the like), a headline 508, paragraph text 512, and a call to action 516. Each component may be customized for each web page. For example, an image may be selected or provided as the background 504. A user may provide text for the headline 508, the paragraph text 512, and a label of the call to action 516. In addition, the action triggered by the call to action 516, such as a transition to another web page, may be customized. For example, a URL may be provided for use in a link to another web page. Selection of the “learn more” button in the rendered web page will trigger the transition to the web page identified by the provided URL.

FIG. 6 illustrates an example user interface 600 for defining the components of the call to action content unit 404, in accordance with an example embodiment. A color scheme of the content unit may be selected via a dropdown menu 604. For example, the color white is selected in the dropdown menu 604. The text of the top headline may be entered via a main headline field 608 and the headline text may be entered via a headline field 612. The paragraph text may be entered via a regular text field 616. The text of the button of the call to action 516 may be entered via a button text field 620, and the URL associated with the call to action 516 may be entered via a button link field 624. As noted above, selection of the call to action 516 will trigger a transition to the web page associated with the URL.

FIGS. 7A and 7B illustrate an example user interface for defining the components of the header large media slideshow content unit 408, in accordance with an example embodiment. An override title may be entered via an override title text field 702 to override the default title of the header large media slideshow content unit 408. A color scheme of the content unit 408 may be selected via a dropdown menu 704. For example, the color white is selected in the dropdown menu 704. The slideshow layout, such as a right-side oriented layout, may be selected via a dropdown menu 708. The slideshow may be enabled or disabled using a dropdown menu 712. Selecting yes from the dropdown menu 712 activates the slideshow and selecting no from the dropdown menu 712 designates slide 1 as a static header. In the latter case, an animated slideshow will not be loaded or displayed. An image for slide 1 may be identified via a slide 1 image field 716 and the text accompanying the image for slide 1 may be entered via a slide 1 text field 724. Selecting a remove button 720 will delete the identified image from the header large media slideshow content unit 408. The button color for slide 1 may be selected via a dropdown menu 728, the label of the button may be entered via a button label text field 732, and the URL of the button for slide 1 may be entered via a button link field 736.

In one example embodiment, a video may also be associated with slide 1. The slide 1 video label may be entered via a video label field 740, the slide 1 video 1 description may be entered via a video description text field 744, and the slide 1 video may be identified via a video identification field 748.

FIG. 8A illustrates an example panel 800 for creating a web page using content units 404, 408, in accordance with an example embodiment. In one example embodiment, the panel 800 is a single page container for one or more stacked content units 404, 408. Content units 404, 408 may be added to, moved within, and/or deleted from panel 800. FIG. 8B illustrates an example user interface for defining a panel 800 comprising a stack of content units 404, 408 in accordance with an example embodiment. Each content unit 404, 408 is represented by a content unit block 804-1 through 804-N (hereinafter content unit blocks 804). Each content unit block 804 includes a content unit type indicator 808 and a content unit title 812. The content unit title 812 is the title, if any, specified in the corresponding content unit (e.g., the override title entered in the override title text field 702). A user may add, move, or delete content unit blocks 804 from the stack using, for example, a drag-and-drop technique. FIG. 8C illustrates an example user interface for accessing content units 404, 408 of a defined panel 800, in accordance with an example embodiment. The content unit blocks 804 have been compressed for easy viewing, but may be selected and expanded prior to editing to show details of the content unit 404, 408, such as the details defined in FIGS. 6, 7A, and 7B.

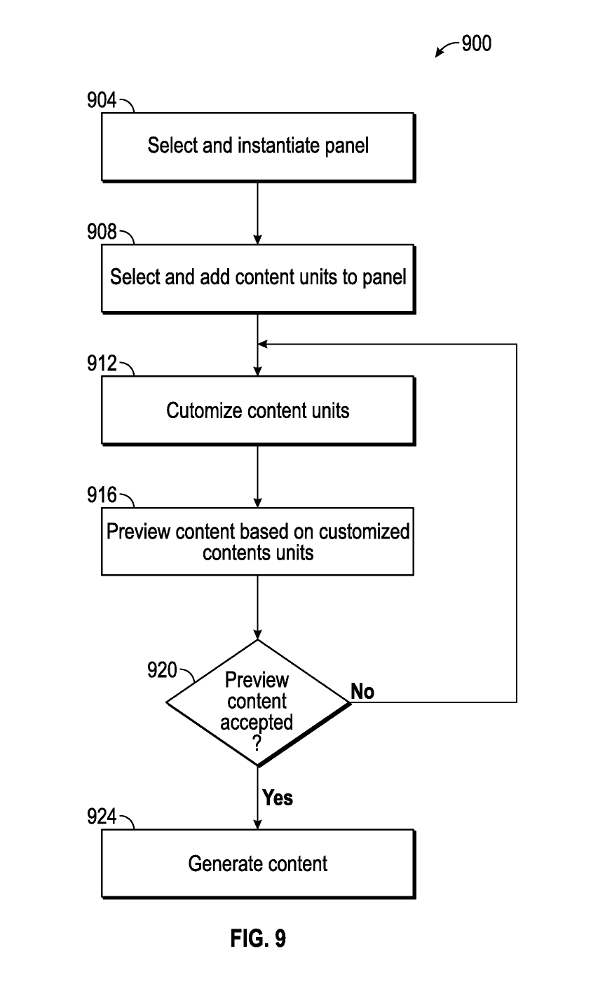

FIG. 9 illustrates an example workflow 900 for creating content, in accordance with an example embodiment. In one example embodiment, a panel 800 is selected and instantiated (operation 904). The panel 800 may be a flexible panel, as illustrated in FIG. 8B, where an arbitrary collection of content units 404, 408 may be stacked, or a predefined panel comprising a predefined stack of content units 404, 408. One or more content units 404, 408 may be added to the selected panel (operation 908). In one example embodiment, content units 404, 408 may be added to, moved within, and/or deleted from the panel 800.

In one example embodiment, a content unit 404, 408 may be customized by selecting the content unit block 804 in the panel 800 and editing one or more of the entry fields of the content unit 404, 408 via, for example, the user interface of FIGS. 7A and 7B (operation 912). The created content may be previewed based on the customized content units 404, 408 (operation 916). A test may then be performed to determine if the previewed content is acceptable (operation 920). For example, a user may preview the content and determine if the content meets the defined content requirements. If the previewed content is not acceptable, the workflow 900 may proceed with operation 912 and one or more of the content units 404, 408 may be further customized; otherwise, the content is generated (operation 924). For example, the web page may be generated in HTML.

FIG. 10 is a flowchart for an example method 1000 for generating content, in accordance with an example embodiment. The method 1000 may be performed by the content generation module 238. In one example embodiment, the content to be generated is a web page and is defined via, for example, the user interface of FIGS. 7A and 7B.

In one example embodiment, a content unit 404, 408 is obtained from the panel 800 (operation 1004) and the content items associated with the content unit 404, 408 are obtained (operation 1008). For example, the text provided by the user, the selections provided by the user (such as a color scheme or layout option), and other content to be incorporated into the generated content (such as an image, video, audio track, and the like) are obtained via the storage interface module 246. The obtained content is forwarded to the content unit Hypertext Preprocessor (PHP) templates and/or theme function of the corresponding content unit type (operation 1012). The content unit PHP templates and/or theme functions generate HTML data based on the customized content unit 404, 408 (operation 1016). A test is then performed to determine if all content units 404, 408 of the panel 800 have been processed (operation 1020). If all content units 404, 408 of the panel 800 have not been processed, the method 1000 proceeds with operation 1004; otherwise, the HTML data is submitted for processing by a theme system, such as the open source content management platform known as the Drupal Theme System, to create a web page capable of being rendered by, for example, a web browser (operation 1024). The theme system may, for example, add JavaScript data, a header(s), a footer(s), and the like to the HTML data to create a web page capable of being rendered.

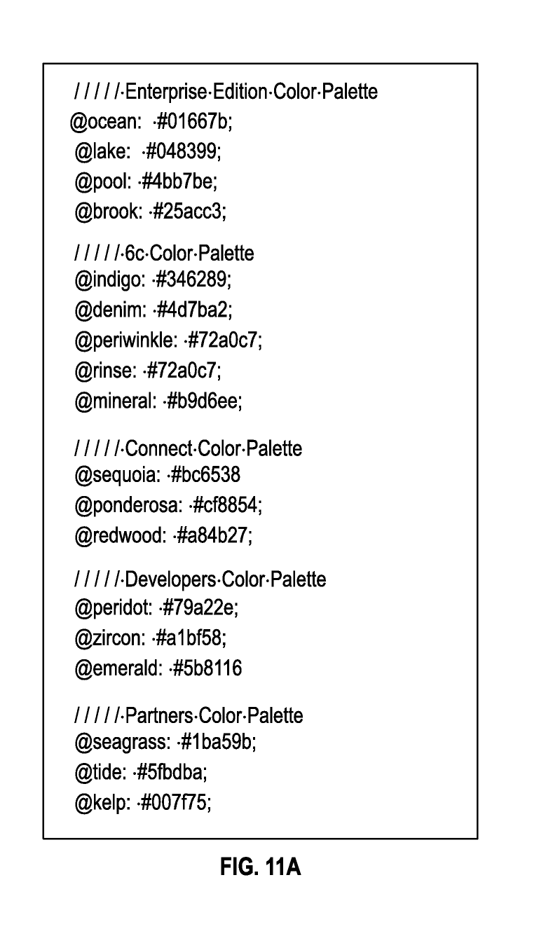

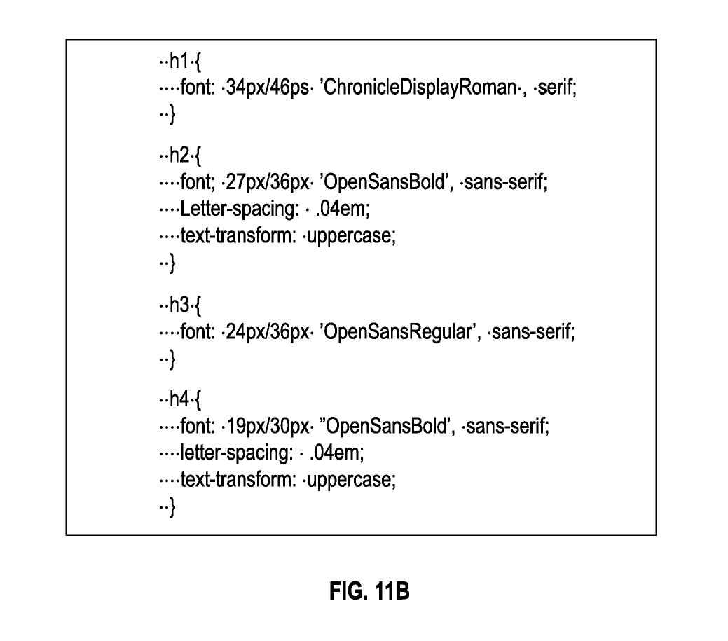

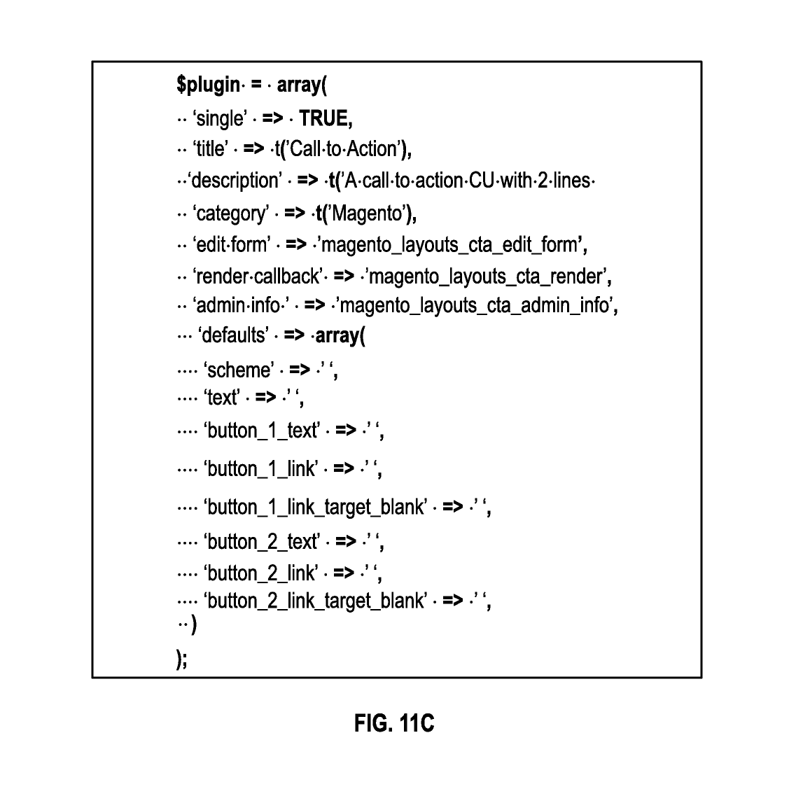

FIGS. 11A-11C are examples of code for defining the style of the content units 404, 408 and specifying the parameters for the content, in accordance with an example embodiment. FIG. 11A illustrates an example of code for mapping user-friendly scheme names to cascading style sheets (CSS) colors. In one example embodiment, the scheme's color palette is defined in the example code of FIG. 11A for easy modification. FIG. 11B illustrates an example of code for text styling for the content units 404, 408. The content units 404, 408 are generated with semantically correct HTML to facilitate consumption by search engines and thus should be styled to ensure proper display. FIG. 11C illustrates an example of code for defining the parameters of the content units 404, 408. In one example embodiment, each element in the array is either a configuration setting (e.g., “category”) or a definition of a field for user input (e.g., “scheme”).

Although certain examples are shown and described herein, other variations exist and are within the scope of the invention. It will be appreciated by those of ordinary skill in the art that any arrangement which is designed or arranged to achieve the same purpose may be substituted for the specific embodiments shown. This application is intended to cover any adaptations or variations of the example embodiments of the invention described herein. It is intended that this invention be limited only by the claims, and the full scope of equivalents thereof.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client, or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via the network 142 (e.g., the Internet) and via one or more appropriate interfaces (e.g., application program interfaces (APIs)).

### Electronic Apparatus and System

Example embodiments may be implemented in digital electronic circuitry, or in computer hardware, firmware, or software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by the network 142.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

A computing system can include clients and servers. A client and server are generally remote from each other and typically interact through the network 142. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed, in various example embodiments.

### Example Machine Architecture and Machine-Readable Medium

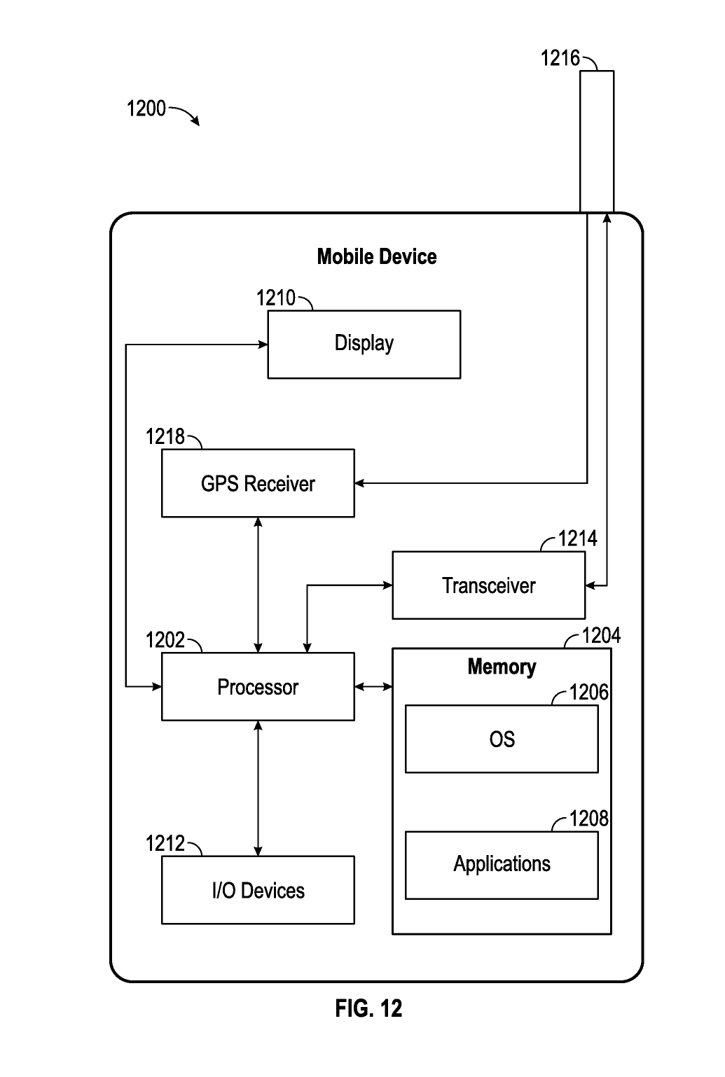

FIG. 12 is a block diagram illustrating an example mobile device 1200, according to an example embodiment. The mobile device 1200 can include a processor 1202. The processor 1202 can be any of a variety of different types of commercially available processors suitable for mobile devices 1200 (for example, an XScale architecture microprocessor, a Microprocessor without Interlocked Pipeline Stages (MIPS) architecture processor, or another type of processor). A memory 1204, such as a random access memory (RAM), a Flash memory, or another type of memory, is typically accessible to the processor 1202. The memory 1204 can be adapted to store an operating system (OS) 1206, as well as applications 1208, such as a mobile location enabled application that can provide location based services (LBSs) to a user. The processor 1202 can be coupled, either directly or via appropriate intermediary hardware, to a display 1210 and to one or more input/output (I/O) devices 1212, such as a keypad, a touch panel sensor, and a microphone. Similarly, in some embodiments, the processor 1202 can be coupled to a transceiver 1214 that interfaces with an antenna 1216. The transceiver 1214 can be configured to both transmit and receive cellular network signals, wireless data signals, or other types of signals via the antenna 1216, depending on the nature of the mobile device 1200. Further, in some configurations, a GPS receiver 1218 can also make use of the antenna 1216 to receive GPS signals.

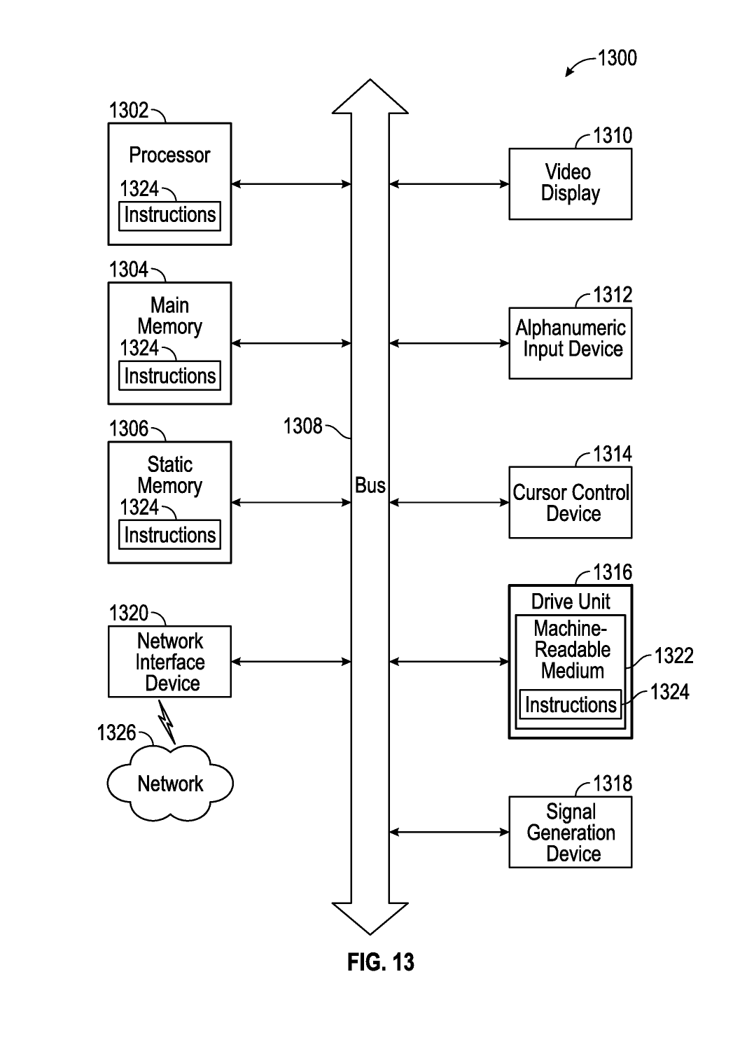

FIG. 13 is a block diagram of a machine in the form of an example computer system 1300 within which instructions 1324 may be executed for causing the machine to perform any one or more of the methodologies discussed herein. In one example embodiment, the machine may be the example apparatus 200 of FIG. 2 for creating content. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1300 includes a processor 1302 (e.g., a central processing unit (CPU), a graphics processing unit (GPU), or both), a main memory 1304, and a static memory 1306, which communicate with each other via a bus 1308. The computer system 1300 may further include a video display unit 1310 (e.g., a liquid crystal display (LCD) or a cathode ray tube (CRT)). The computer system 1300 also includes an alphanumeric input device 1312 (e.g., a keyboard), a cursor control device 1314 (e.g., a mouse), a drive unit 1316, a signal generation device 1318 (e.g., a speaker), and a network interface device 1320.

### Machine-Readable Medium

The drive unit 1316 includes a machine-readable medium 1322 on which is stored one or more sets of data structures and instructions 1324 (e.g., software) embodying or utilized by any one or more of the methodologies or functions described herein. The data structures and instructions 1324 may also reside, completely or at least partially, within the main memory 1304 and/or within the processor 1302 during execution thereof by the computer system 1300, the main memory 1304 and the processor 1302 also constituting machine-readable media. The data structures and instructions 1324 may also reside within the static memory 1306.

While the machine-readable medium 1322 is shown in an example embodiment to be a single medium, the term “machine-readable medium” may include a single medium or multiple media (e.g., a centralized or distributed database, and/or associated caches and servers) that store the one or more data structures and instructions 1324. The term “machine-readable medium” shall also be taken to include any tangible medium that is capable of storing, encoding, or carrying data structures and instructions 1324 for execution by the machine and that cause the machine to perform any one or more of the methodologies of the present invention, or that is capable of storing, encoding, or carrying data structures utilized by or associated with such data structures and instructions 1324. The term “machine-readable medium” shall accordingly be taken to include, but not be limited to, solid-state memories, and optical and magnetic media. Specific examples of machine-readable media 1322 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

### Transmission Medium

The data structures and instructions 1324 may further be transmitted or received over a communications network 1326 using a transmission medium. The data structures and instructions 1324 may be transmitted using the network interface device 1320 and any one of a number of well-known transfer protocols (e.g., Hypertext Transfer Protocol (HTTP)). Examples of communications networks 1326 include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying data structures and instructions 1324 for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. An apparatus for creating content comprising:
a panel instantiation module, executing on at least one computer processor, for instantiating a panel;
a content unit selection module for selecting a content unit type and adding a content unit corresponding to the selected content unit type to the panel;
a content unit editing module for customizing the content unit; and
a content generation module for generating the content based on one or more customized content units.

2. The apparatus of claim 1, further comprising a panel editing module for moving the content unit within the panel and for deleting the content unit from the panel.

3. The apparatus of claim 1, further comprising a user interface module for defining and editing the content unit.

4. The apparatus of claim 1, wherein the content unit defines one or more of a color, a layout, a background, a text field, an action button, a link to a web page, and an identity and position of ancillary content to be imported into a corresponding rendered content unit.

5. The apparatus of claim 1, wherein a location of the content unit in the panel indicates a position of a corresponding rendered content unit within a web page.

6. The apparatus of claim 4, wherein the action button defines a button in the corresponding rendered content unit that enables a user of the rendered content unit to trigger an action.

7. The apparatus of claim 6, wherein the action is a transition to a web page via a link.

8. A method for creating content, the method comprising:
instantiating a panel;
selecting a content unit type;
adding a content unit corresponding to the selected content unit type to the panel;
customizing the content unit; and
generating the content based on one or more customized content units.

9. The method of claim 1, further comprising moving the content unit within the panel.

10. The method of claim 1, further comprising defining and editing the content unit.

11. The method of claim 1, wherein the content unit defines one or more of a color, a layout, a background, a text field, an action button, a link to a web page, and an identity and position of ancillary content to be imported into a corresponding rendered content unit.

12. The method of claim 1, wherein a location of the content unit in the panel indicates a position of a corresponding rendered content unit within a web page.

13. The method of claim 11, wherein the action button defines a button in the corresponding rendered content unit that enables a user of the rendered content unit to trigger an action.

14. The method of claim 13, wherein the action is a transition to a web page via a link.

15. A non-transitory computer-readable medium embodying instructions that, when executed by a processor, perform operations comprising:
instantiating a panel;
selecting a content unit type;
adding a content unit corresponding to the selected content unit type to the panel;
customizing the content unit; and
generating the content based on one or more customized content units.

16. The non-transitory computer-readable medium of claim 15, further comprising instructions that, when executed by a processor, perform operations comprising defining and editing the content unit.

17. The non-transitory computer-readable medium of claim 15, wherein the content unit defines one or more of a color, a layout, a background, a text field, an action button, a link to a web page, and an identity and position of ancillary content to be imported into a corresponding rendered content unit.

18. The non-transitory computer-readable medium of claim 15, wherein a location of the content unit in the panel indicates a position of a corresponding rendered content unit within a web page.

19. The non-transitory computer-readable medium of claim 17, wherein the action button defines a button in the corresponding rendered content unit that enables a user of the rendered content unit to trigger an action.

20. The non-transitory computer-readable medium of claim 19, wherein the action is a transition to a web page via a link.
